(19) United States
(12) Patent Application Publication
(10) Pub. No.: US 2024/0117932 A1
(43) Pub. Date: Apr. 11, 2024

(54) PRESSURIZED GAS CONTAINMENT LINER, ASSOCIATED PRESSURIZED GAS TANK AND ASSOCIATED METHOD FOR MANUFACTURING A PRESSURIZED GAS CONTAINMENT LINER

(71) Applicant: FAURECIA SYSTEMES D'ECHAPPEMENT, Nanterre (FR)

(72) Inventors: Christophe BAVEREL, AUDINCOURT (FR); Dorian HERNANDEZ, JONCHEREY (FR); David FARALDI, MONTBELIARD (FR); Marc MORET, LA CHAPELLE SUR ERDRE (FR); Thomas BRANGER, MONTAIGU (FR)

(21) Appl. No.: 18/375,643

(22) Filed: Oct. 2, 2023

(30) Foreign Application Priority Data
Oct. 5, 2022 (FR) 22 10190

(51) Int. Cl. F17C 1/08

(52) U.S. Cl. CPC F17C 1/08; F17C 2203/0604; F17C 2203/0612; F17C 2221/012

(57) ABSTRACT

A pressurized gas containment liner includes a first part comprising a first shell with a first peripheral edge, and a second part comprising a second shell with a second peripheral edge. A strip is superimposed on the first peripheral edge and on the second peripheral edge. The strip rigidly connects the first part and the second part to each other, and the first part, the second part, and the strip delimit an interior volume between them. The pressurized gas containment liner further includes at least one pillar passing through the interior volume and connecting the first and the second shells.

### CROSS-REFERENCE TO RELATED APPLICATION

This application is a U.S. non-provisional application claiming the benefit of French Application No. 22 10190, filed on Oct. 5, 2022, which is incorporated herein by reference in its entirety.

### TECHNICAL FIELD

The present disclosure relates to a pressurized gas containment liner. The disclosure relates to a pressurized gas tank comprising such a liner as well as a method for manufacturing such a liner.

### BACKGROUND

In the field of transport means, and in particular in automotive transport, it may prove important to contain pressurized gas. This proves all the more true with the growth of vehicles provided with fuel cells, for which dihydrogen intended to supply a fuel cell must be stored in the vehicle.

It is known to use cylindrical tanks for the containment of pressurized gas in vehicles. Such tanks are generally provided with a cylindrical compression liner, arranged inside a body of the tank, and aiming to ensure the containment of the pressurized gas within the tank.

Such liners, and more generally such tanks, however, are not entirely satisfactory due to their shape which is sometimes unsuitable for the layout of a vehicle.

It has therefore been proposed to use non-cylindrical tanks, for example prismatic tanks. Such tanks generally have the shape of a flattened prism, making it possible to improve the integration of the tank in the vehicle.

However, such tanks are not entirely satisfactory. Specifically, it has been shown that due to their non-cylindrical shape, the tanks are less robust. It has then been necessary to reinforce the tanks locally in order to improve their robustness, and to adapt the liners to such reinforcements. However, the manufacture of such liners has proven complex.

Thus, one of the aims of the disclosure is to propose a gas containment liner allowing easier integration into a vehicle while being inexpensive to manufacture and making it possible to obtain a robust tank.

### SUMMARY

To this end, the disclosure relates to a pressurized gas containment liner, comprising:
a first part, comprising a first shell comprising a first peripheral edge,
a second part, comprising a second shell comprising a second peripheral edge,
a strip, being superimposed on the first peripheral edge and on the second peripheral edge, the strip rigidly connecting the first part and the second part to each other,
the first part, the second part and the strip delimiting an interior volume between them,
the pressurized gas containment liner further comprising,
at least one pillar, passing through the interior volume and connecting the first and the second shells.

The use of a strip rigidly connecting the first and the second part as well as pillars connecting these parts allows for particularly uncomplicated assembly of a liner that can accommodate reinforcement elements in order to obtain a tank whose robustness is improved.

According to other advantageous aspects of the disclosure, the containment liner comprises one or more of the following features, taken alone or in any technically feasible combination:
the strip extends at least partially on an interior face of the first shell and/or of the second shell;
the strip comprises a portion protruding in an orientation directed away from the interior volume, the protruding portion extending at least partially between the first and the second peripheral edges;
the pillar is hollow, the pillar comprising a pillar wall delimiting a pillar cavity, the pillar comprising an opening on the cavity at each of its ends, the first shell comprising an orifice arranged opposite one of the openings and the second shell comprising an orifice arranged opposite the other of the openings;
the pillar cavity has at each of its ends a widening toward each of the openings;
the pillar comprises a first flared end connected to the first shell and a second flared end connected to the second shell, the outer section of the first flared end widening toward the first shell and the outer section of the second flared end widening toward the second shell;
the first and the second parts are made of a material configured to be transparent to laser radiation, the pillar and the strip being made of a material configured to absorb the laser radiation, the strip and the pillar being welded to the first part and to the second part by laser welding; and
the strip and the pillar are rigidly connected to the first part and to the second part by butt welding, a resistive sheet being arranged between adjacent edges of the strip and the first or the second part and/or between adjacent edges of the pillar and of the first or the second part.

The disclosure further relates to a pressurized gas tank comprising a pressurized gas containment liner as mentioned above, and a tank body arranged around the pressurized gas containment liner, an inner face of the tank body being affixed to an outer face of the pressurized gas containment liner.

The disclosure further relates to a method for manufacturing a pressurized gas containment liner as mentioned above, comprising the following steps:
providing a first part, a second part, a pillar, and a strip;
rigidly connecting the pillar to the first and second parts and rigidly connecting the strip to the first and second parts.

### BRIEF DESCRIPTION OF THE DRAWINGS

The disclosure will be better understood on reading the following description, given solely by way of non-limiting example, and referring to the drawings in which:

FIG. 1 is a partial perspective view of a tank comprising a liner according to the disclosure, during the manufacturing of the tank;

FIG. 2 is a cross-sectional view of the tank of FIG. 1 along a cutting plane II-II, the manufacturing of the tank being completed;

FIG. 3 is a perspective view of the tank of FIG. 1 in its entirety; and

FIG. 4 is a sectional view along the plane II-II of a detail of the rigid connection between two parts of a liner according to an alternative embodiment to the embodiment shown in FIGS. 1 to 3.

### DETAILED DESCRIPTION

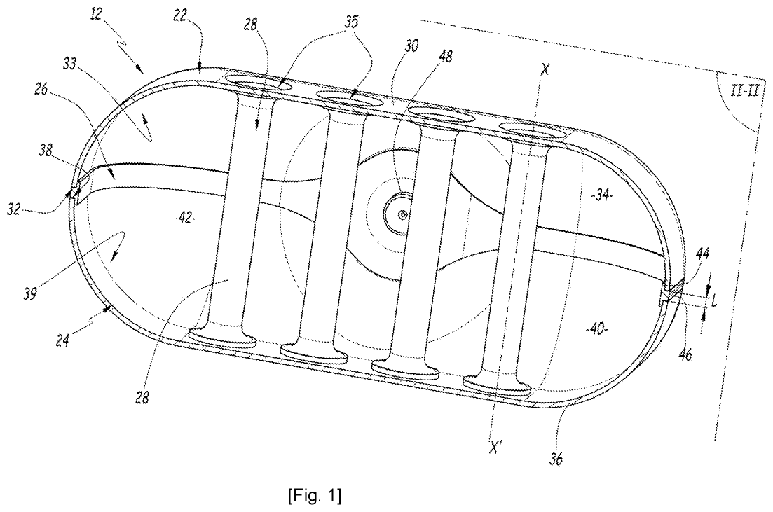

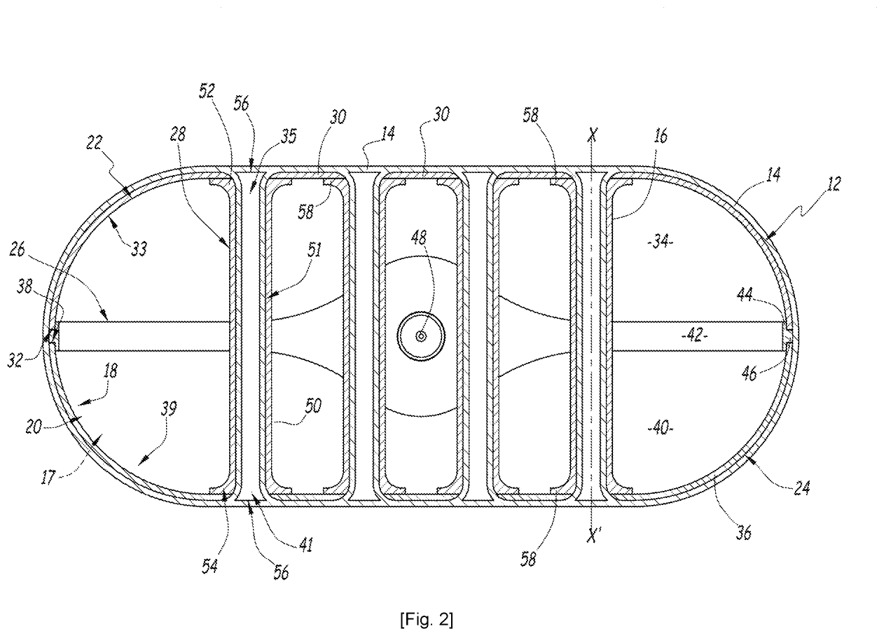

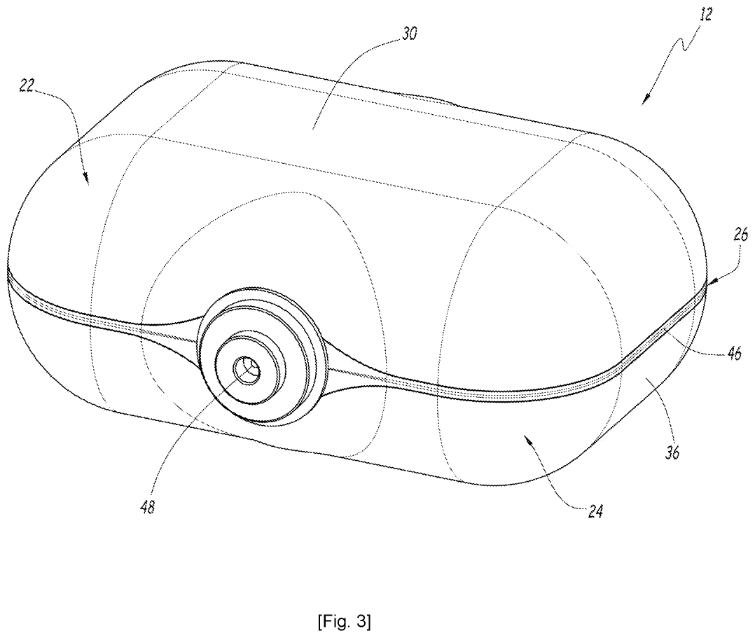

With reference to FIGS. 1 to 3, a pressurized gas tank 10 comprises a pressurized gas containment liner 12. As can be seen in FIG. 2, the tank 10 further comprises a tank body 14 as well as at least one tank column 16.

The pressurized gas tank 10 is configured to contain a pressurized gas such as, for example, a reducing fuel gas and such as in particular pressurized hydrogen. The pressurized gas tank 10 is, for example, configured to contain a gas at a pressure greater than 200 bar and for example a gas at a pressure of 350 bar or a gas at a pressure of 700 bar. The pressurized gas tank 10 is further, for example, configured to contain a liquid, such as a liquid phase of the pressurized gas contained in the tank 10, for example.

The pressurized gas tank 10 is, for example, intended to be installed in a vehicle, for example a motor vehicle. The pressurized gas tank 10 is, for example, configured to supply fuel to a fuel cell of the vehicle (not shown).

The tank body 14, for example, forms a body volume 17 wherein the liner 12 is housed. The tank body 14 comprises, for example, an inner face 18 defining the body volume 17. The tank body 14 is, for example, produced around the liner 12 so that the liner 12 is arranged in the tank body 14, the inner face 18 being, for example, affixed to an outer face 20 of the liner.

The tank body 14 is, for example, made from composite. The composite from which the tank body 14 is made comprises, for example, a resin such as: an epoxy resin, or a resin made from at least one thermoplastic polymer selected from the group consisting of polyolefins, in particular polypropylene, polyamides, in particular aliphatic polyamides, such as polycaprolactam PA 6, polyhexamethylene adipamide PA 6.6, polycarbonates, PAEK (polyaryletherketone), including PEEK (polyetheretherketone) and PEKK (polyetherketoneketone), acrylic-based materials such as PMMA (including the resin known as ELIUM), PEI (polyetherimide also known as ULTEM), PPS (polyphenylene sulfide), ABS (acrylonitrile butadiene styrene), PLA (polylactic acid), TPU (thermoplastic polyurethane) and PET (polyethylene), and mixtures thereof.

The composite from which the tank body 14 is made comprises, for example, a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers.

As can be seen in FIG. 2, each tank column 16 extends into the body volume 17 and connects for example portions of the inner face 18 of the tank body 14 opposite to each other relative to the body volume 17.

Each tank column 16 is, for example, welded to the tank body 14 at each of the ends of the column 16 and/or made so as to form a single piece with the tank body 14.

Each tank column 16 is, for example, made from composite. The composite from which each tank column 16 is made comprises, for example, a resin such as: an epoxy resin, or a resin made from at least one thermoplastic polymer selected from the group consisting of polyolefins, in particular polypropylene, polyamides, in particular aliphatic polyamides, such as polycaprolactam PA 6, polyhexamethylene adipamide PA 6.6, polycarbonates, PAEK (polyaryletherketone), including PEEK (polyetheretherketone) and PEKK (polyetherketoneketone), acrylic-based materials such as PMMA (including the resin known as ELIUM), PEI (polyetherimide also known as ULTEM), PPS (polyphenylene sulfide), ABS (acrylonitrile butadiene styrene), PLA (polylactic acid), TPU (thermoplastic polyurethane) and PET (polyethylene), and mixtures thereof.

The composite from which each tank column 16 is made comprises, for example, a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers.

In a particular embodiment, the material of the tank columns 16 is the same as the material of the tank body 14.

As shown in FIG. 2, each tank column 16 is, for example, hollow.

As seen above, the liner 12 is, for example, arranged in the body volume 17.

The liner 12 is configured to ensure that the tank 10 is leaktight to the pressurized gas while the tank body 14 is configured to ensure that the pressurized gas is pressure-resistant.

As shown in FIGS. 1 and 2, the liner 12 comprises a first part 22, a second part 24, a strip 26, and at least one pillar 28.

As shown in FIGS. 1 and 2, the liner 12 preferably comprises a plurality of pillars 28 and, for example, at least four pillars.

The first part 22, the second part 24, the strip 26, and the at least one pillar 28 are, for example, made of a thermoplastic material chosen from the list consisting of ABS (acrylonitrile butadiene styrene), PA (polyamide), PE (polyethylene), PC (polycarbonate), PP (polypropene), PMMA (polymethyl methacrylate), PS (expanded polystyrene), PBT (polybutylene terephthalate). The material of the first part 22, the second part 24, the strip 26 and the at least one pillar 28 is for example more particularly chosen from the list consisting of: PA6 (polycaprolactam), PA11 (polyundecanamide) or PA12 (Nylon 12).

As will be described in more detail below, the thermoplastic material chosen to produce the first part 22, the second part 24, the strip 26, or the at least one pillar 28 may comprise an additive.

As shown in FIGS. 1 and 2, the first part 22 comprises a first shell 30 comprising a first peripheral edge 32 and an interior face 33. The first shell 30, and more particularly the interior face 33 of the first shell, delimits a first concave space 34, open along the first peripheral edge 32. As will be described in more detail below, the first shell 30 comprises, for example, at least one orifice 35 opening onto the first concave space 34 opposite the first peripheral edge 32.

As shown in FIGS. 1 and 2, the second part 24 comprises a second shell 36 comprising a second peripheral edge 38 and an interior face 39. The second shell 36, and more particularly the interior face 39 of the second shell 36, delimits a second concave space 40, open along the second peripheral edge 38. As will be described in more detail below, the second shell 36 comprises, for example, at least one orifice 41 opening onto the second concave space 40 opposite the second peripheral edge 38.

The first part 22 and the second part 24 are arranged facing each other, the first peripheral edge 32 being, for example, arranged opposite the second peripheral edge 38. The first concave space 34 and the second concave space 40 then emerge facing one another.

The strip 26 is superimposed on the first peripheral edge 32 and the second peripheral edge 40. In other words, the strip 26 extends opposite each of the first 32 and second peripheral edges 40. The strip 26 in particular connects the first peripheral edge 32 and the second peripheral edge 40.

As shown in FIGS. 1 and 2, the strip 26 connects the first part 22 and the second part 24.

The first part 22, the second part 24, and the strip 26 delimit an interior volume 42 between them. The interior volume 42 thus delimited is configured to be occupied by the pressurized gas.

The strip 26, for example, extends at least partially on the interior face 33 of the first shell 30 and/or on the interior face 39 of the second shell 36.

In the example of FIGS. 1 to 3, the strip 26 extends over the interior face 33 of the first shell 30 along the first peripheral edge 32, and thus extends partially into the first concave space 34. The strip 26 further extends over the interior face 39 of the second shell 36 along the second peripheral edge 38, and thus extends partially into the second concave space 40.

As can be seen in FIGS. 1 and 2, the strip 26 comprises, for example, an interior portion 44 and a protruding portion 46. The strip 26, for example, accommodates at least one port 48 for access to the interior volume 42. In the example of FIGS. 1 to 3, the strip receives two ports 48 for access to the interior volume 42.

The protruding portion 46 protrudes from the interior portion 44 away from the interior volume 42. The protruding portion 46 extends, for example, at least partially between the first peripheral edge 32 and the second peripheral edge 38.

As can be seen in FIGS. 1 to 3, a width L of the protruding portion 46 corresponds to the spacing between the first part 22 and the second part 24, and in particular between the first peripheral edge 32 and the second peripheral edge 38.

As can be seen in FIGS. 1 and 2, the width L of the protruding portion 46 is variable along the peripheral edges 32, 38. In particular, and as will be described in more detail below, the width L is maximal around the at least one access port 48.

The interior portion 44, for example, protrudes on either side of the protruding portion 46 on the interior face 33 of the first shell 30 and on the interior face 39 of the second shell 36, along the first peripheral edge 32 and the second peripheral edge 38.

As shown in FIGS. 1 and 2, the port 48 is arranged through the strip 26. The port 48 is, for example, arranged through the protruding portion 46. Each port 48 of the tank 10 is, for example, housed in the strip 26 to allow access to the interior volume 42, for example for filling the interior volume 42 with pressurized gas and/or emptying it of same.

As shown in FIGS. 1 and 2, the at least one pillar 28 passes through the interior volume 42 and connects the first shell 30 and the second shell 36.

The pillar 28 is for example elongated along an elongation axis X-X′ between its first end 52 and its second end 54, the first end 52 of the pillar 28 being connected to the first shell 30 and the second end 54 of the pillar 28 being connected to the second shell 36.

The pillar 28 is, for example, hollow. The pillar 28 comprises, for example, a pillar wall 50 delimiting a pillar cavity 51. The pillar 28 then comprises, for example, an opening 56 on the cavity 51 at each of its ends 52, 54. The orifice 35 of the first shell 30 is then, for example, arranged opposite one of the openings 56, the orifice 41 of the second shell 36 then being arranged opposite the other of the openings 56.

As shown in FIG. 2, a tank column 16 is, for example, housed in the cavity 51 of each pillar 28, the tank column 16 extending, for example, on either side of the cavity 51 through the openings 56. The column 16 thus housed further passes through, for example, the first shell 30 and the second shell 36 through the orifices 35, 41 of these liners 30, 36, the column 16 thus being connected to the tank body 14 on both sides of the liner 12.

As can be seen in FIG. 2, the pillar cavity 51 has, for example, at each of its ends, that is, at each of the ends 52, 54 of the pillar, a widening 58 towards each of its openings 56.

As shown in FIG. 2, the first end 52 and the second end 54 are furthermore for example flared, the outer section of the first end 52 thus widening toward the first shell 30 and the outer section of the second end 54 thus widening toward the second shell 36.

As shown in FIG. 2, the widening 58 of the cavity 51 at each of its ends corresponds, for example, to the flaring of the outer section at each of the ends 52, 54, the pillar wall being of substantially constant thickness along the pillar 28.

In the example shown in FIGS. 1 to 3, the first part 22 and the second part 24 are made of a material configured to be transparent to laser radiation. The pillar 28 and the strip 26 are furthermore made of a material configured to absorb laser radiation.

The material configured to be transparent to laser radiation is, for example, made of one of the thermoplastic materials presented above, said thermoplastic material being free of light absorption additive.

The material configured to absorb laser radiation is, for example, made from one of the thermoplastic materials presented above, said thermoplastic material comprising a light absorption additive, such as carbon for example.

In a particular embodiment, the material configured to be transparent to laser radiation and the material configured to absorb laser radiation are made from the same thermoplastic material, the difference between these materials being that the material configured to absorb laser radiation is treated using a light absorption additive while the material configured to be transparent to laser radiation is not treated using such an additive.

The strip 26 and the pillar 28 are then welded to the first part 22 and to the second part 24 by laser welding.

The strip 26 is thus welded on the one hand to the first part 22 and on the other hand to the second part 24 by laser welding. In particular, the interior portion 44 of the strip 26 is, for example, welded to the interior faces 33, 39 through the liners 30, 36, along the peripheral edges 32, 38, by laser welding.

The pillar 28 is thus welded on the one hand to the first part 22 and on the other hand to the second part by laser welding. In particular, the ends 52, 54 of the pillar are, for example, welded to the interior faces 33, 39 through the liners 30, 36, around the orifices 41 by laser welding.

A second embodiment of a liner 12 for compressing pressurized gas will now be presented. According to this second embodiment, the liner 12 differs from the embodiment presented above. Similar elements bear the same references.

In this second embodiment, the strip 26 and the pillar 28 are not rigidly connected to the first part 22 and to the second part 24 by laser welding, but are rigidly connected to the first part 22 and to the second part 24 by butt welding.

To this end, the pillars 28 and the strip 26 are not necessarily made of a material configured to absorb a laser beam and the first 22 and the second 24 parts are not necessarily made of a material configured to be transparent to laser radiation.

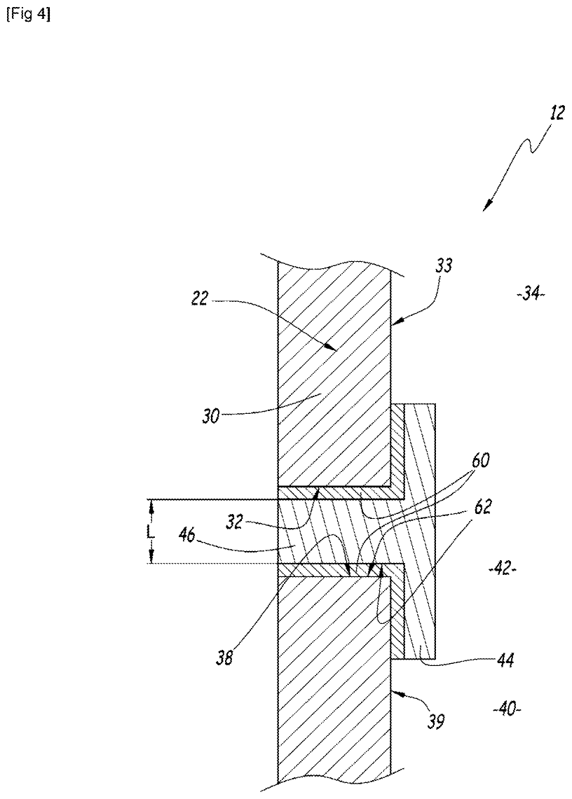

In this embodiment, and as shown in FIG. 4, a resistive sheet 60 is arranged between adjacent edges 62 of the strip and the first 22 or second 24 part and/or between adjacent edges (not shown) of the pillar 28 and the first 22 or second 24 part. In the embodiment shown in FIG. 4, a first resistive sheet 60 extends between a first flank of the protruding portion 46 and the first peripheral edge 32 on the one hand, and between a second flank of said protruding portion 46 and the second peripheral edge 38. In this embodiment, the resistive sheet 60 further extends between the interior portion 44 on the one hand and the interior faces 33, 39 on the other hand.

A third embodiment of a liner 12 for compressing pressurized gas will now be presented. According to this third embodiment, the liner 12 differs from the embodiments presented above. Similar elements bear the same references.

In this third embodiment, the first part 22, the strip 26 and the pillar 28 are neither rigidly connected to the first part 22 and to the second part 24 by butt welding, nor by laser welding, but are rigidly connected by hot gas welding.

To this end, the pillars 28 and the strip 26 are not necessarily made of a material configured to absorb a laser beam and the first 22 and the second 24 parts are not necessarily made of a material configured to be transparent to laser radiation. No resistive sheet is further arranged the adjacent edges 62 of the strip 26 and of the first 22 or second 24 part and/or between the adjacent edges 62 of the pillar 28 and of the first 22 or the second part 24.

The strip 26 is, for example, rigidly connected to the first shell 30 and to the second shell 36 by heating portions of the strip 26 and/or portions of the adjacent and/or superimposed shells 30, 36 by heating using a hot gas, such as hot air.

A method for manufacturing a pressurized gas containment liner 12 as described above will now be presented.

During a first step, a first part 22, a second part 24, a pillar 28, and a strip 26 are provided.

During a second step, the pillar 28 is rigidly connected to the first part 22 and to the second part 24, and the strip 26 is rigidly connected to the first part 22 and to the second part 24.

According to the first embodiment presented above, the securing of the pillar 28 to the first part 22 and to the second part 24, and the securing of the strip 26 to the first part 22 and to the second part 24, is carried out by laser welding. To this end, a laser beam is pointed on the pillar 28, absorbing the laser beam, through the first part 22 and the second part 24, transparent to the laser ray. Local heating of the pillar 28 associated with the absorption of the laser beam causes local melting of the pillar as well as of portions of the first part 22 and of the first part 24 adjacent to the locally melted portions of the pillar 28, resulting in the fastening by laser welding of the pillar 28 and of the first 22 and second 24 parts. In the same way, a laser beam is pointed on the strip 26, absorbing the laser ray, through the first part 22 and the second part 24, transparent to the laser ray, resulting in the fastening by laser welding of the strip 26 and of the first 22 and second 24 parts.

According to the second embodiment presented above, the rigid connection of the pillar 28 to the first part 22 and to the second part 24, and the rigid connection of the strip 26 to the first part 22 and to the second part 24, is carried out by butt welding. The resistive sheet 60 is arranged between the adjacent edges 62 of the strip and of the first 22 or second 24 part and between adjacent edges (not shown) of the pillar 28 and of the first 22 or second 24 part. A current is then generated through the resistive sheet 60 for its heating by the Joule effect. The adjacent edges 62 are thus heated, resulting in the adjacent edges 62 being welded to the resistive sheet 60.

According to the third embodiment presented above, the rigid connection of the pillar 28 to the first part 22 and to the second part 24, and the rigid connection of the strip 26 to the first part 22 and to the second part 24, are carried out by hot gas welding.

The heating of adjacent parts for their local melting and for the resulting weld is then carried out by way of a hot gas jet.

It will be understood that the various welding modes presented in the three above embodiments can be combined and are, for example, interchangeable. For example, the strip 26 is welded to the first part 22 and to the second part 24 by butt welding and the pillar 28 is rigidly connected to the first part 22 and to the second part 24 by laser welding.

The disclosure has been shown and described in detail in the drawings and the preceding description. This must be considered as illustrative and given by way of example and not as limiting the disclosure to this only description. Many alternative embodiments are possible.

1. A pressurized gas containment liner, comprising:
a first part, comprising a first shell comprising a first peripheral edge;
a second part, comprising a second shell comprising a second peripheral edge;
a strip superimposed on the first peripheral edge and on the second peripheral edge, the strip rigidly connecting the first part and the second part to each other;
the first part, the second part, and the strip delimiting an interior volume between them,
the pressurized gas containment liner further comprising; and
at least one pillar, passing through the interior volume and connecting the first shell and the second shell.

2. The pressurized gas containment liner according to claim 1, wherein the strip extends at least partially on an interior face of the first shell and/or the second shell.

3. The pressurized gas containment liner according to claim 1, wherein the strip comprises a portion protruding in an orientation directed away from the interior volume, the portion extending at least partially between the first peripheral edge and the second peripheral edge.

4. The pressurized gas containment liner according to claim 1, wherein the at least one pillar is hollow, the at least one pillar comprising a pillar wall delimiting a pillar cavity, the at least one pillar comprising an opening on the pillar cavity at each end of the pillar cavity, the first shell comprising an orifice arranged opposite one of the openings and the second shell comprising an orifice arranged opposite the other of the openings.

5. The pressurized gas containment liner according to claim 5, wherein each end of the pillar cavity has a widening toward each of the openings.

6. The pressurized gas containment liner according to claim 1, wherein the at least one pillar comprises a first flared end connected to the first shell and a second flared end connected to the second shell, an outer section of the first flared end widening toward the first shell and an outer section of the second flared end widening toward the second shell.

7. The pressurized gas containment liner according to claim 1, wherein the first part and the second part are made of a material configured to be transparent to laser radiation, the at least one pillar and the strip being made of a material configured to absorb the laser radiation, the strip and the at least one pillar being welded to the first part and to the second part by laser welding.

8. The pressurized gas containment liner according to claim 1, wherein the strip and the at least one pillar are rigidly connected to the first part and the second part by butt welding, a resistive sheet being arranged between adjacent edges of the strip and the first part or the second part and/or between adjacent edges of the at least one pillar and the first part or second part.

9. A pressurized gas tank comprising the pressurized gas containment liner according to claim 1, and a tank body arranged around the pressurized gas containment liner, an inner face of the tank body being affixed to an outer face of the pressurized gas containment liner.

10. A method for manufacturing a pressurized gas containment liner according to claim 1, comprising the following steps:
providing a first part, a second part, a pillar, and a strip;
rigidly connecting the pillar to the first part and the second part and rigidly connecting the strip to the first part and the second part.
